(19) United States
(12) Patent Application Publication
(10) Pub. No.: US 2015/0206427 A1
(43) Pub. Date: Jul. 23, 2015

(54) PREDICTION OF LOCAL AND NETWORK-WIDE IMPACT OF NON-RECURRENT EVENTS IN TRANSPORTATION NETWORKS

(71) Applicant: International Business Machines Corporation, Armonk, NY (US)

(72) Inventors: Sebastien Blandin, Singapore (SG); Vikneswaran Gopal, Singapore (SG); Laura Wynter, Westport, CT (US)

(73) Assignee: International Business Machines Corporation, Armonk, NY (US)

(21) Appl. No.: 14/158,402

(22) Filed: Jan. 17, 2014

(51) Int. Cl. G08G 1/01; G06N 7/00; G06N 5/04

(52) U.S. Cl. CPC G08G 1/0129; G06N 5/04; G06N 7/005

(57) ABSTRACT

A method (and structure) for predicting an impact of an incident on a system. Incident properties and traffic conditions of at least one historical incident are received, to calibrate one or more parameters of a traffic model, as executed by a processor on a computer. Current traffic conditions, a prediction of recurrent traffic conditions, and an indication of a current incident on the system are received. A duration of the current incident and traffic conditions at a location at which the current incident occurs are predicted. Predicted traffic conditions in the system are calculated, based on the calibrated model parameters, the current traffic conditions, the prediction of recurrent traffic conditions, and the predicted duration of the current incident and traffic conditions at the current incident location.

### BACKGROUND OF THE INVENTION

1. Field of the Invention

The present invention generally relates to traffic management. More specifically, a method predicts the impact of an incident by reading incident properties, current and historical traffic conditions, and a prediction of recurrent traffic conditions, to predict the duration of the incident and traffic conditions at the location at which the incident occurs.

2. Description of the Related Art

The need for efficient monitoring and management of transportation networks, driven by the growth of large cities worldwide, motivates the development of improved forecasting capabilities, required for the shift from a paradigm of reactive control methods, to a paradigm of proactive control actions.

In the context of recurrent congestion, resulting from a structural lack of capacity at peak hours, statistical methods able to leverage large volumes of historical and online data have been shown to provide accurate predictions up to one hour in the future. However, for non-recurrent events such as traffic accidents, occurring outside of peak hours, and known to account for about half of the total delay in the US, innovative techniques are required for handling both the complex causal structure of incident duration and impact, as well as the relatively low volume of available data.

### SUMMARY OF THE INVENTION

In view of the foregoing, and other, exemplary problems, drawbacks, and disadvantages of the conventional systems, it is an exemplary feature of the present invention to provide a structure (and method) for performing real-time prediction of road traffic incident impact on the network.

An exemplary feature of the present invention is that it provides a method that leverages data commonly available today on most transportation networks.

In a first aspect of the present invention, to achieve the above features and objects, described herein is a method for predicting an impact of an incident on a system, including reading incident properties and traffic conditions of at least one historical incident to calibrate one or more parameters of a traffic model, as executed by a processor on a computer; receiving current traffic conditions and a prediction of recurrent traffic conditions; receiving an indication of a current incident in the system; predicting a duration of a current incident and traffic conditions at a location at which the current incident occurs; and calculating a prediction of traffic conditions in the system, based on the calibrated model parameters, the current traffic conditions, the prediction of recurrent traffic conditions, and the predicted duration of the current incident and traffic conditions at the current incident location.

In a second exemplary aspect, also described herein is an apparatus that executes processing to achieve this method for predicting an impact of an incident on a system.

In a third exemplary aspect, also described herein is a computer storage device that stores a set of instructions for executing the processing to achieve this method for predicting an impact of an incident on a system.

The present invention uses a statistical hierarchical approach that is suitable even for low volumes of heterogeneous data, with a causal flow model of impact propagation on a network. It provides an approach that takes a predictive and global view of the traffic incident handling problem, thereby providing a considerable improvement beyond the state of current practice.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows an exemplary high-level view flowchart 100 of the method of the present invention;

FIG. 2 shows an exemplary home screen presentation 200 of a graphical user interface (GUI) of an exemplary prototype of a tool developed by the present inventors as embodying the concepts of the present invention;

FIG. 3A shows a first example representation 300 of an historical incident, as would appear from the “Incident” tab 202;

FIG. 3B shows the representations generated when the “Prediction” tab 203 is selected;

FIGS. 4A and 4B show representations 400,410 for a second historical incident;

FIGS. 5A and 5B show representations 500,510 for a third incident;

FIGS. 6A and 6B show representations 600,610 for a fourth incident;

FIG. 7 shows in block diagram format 700 the major modules of the present invention;

FIG. 8 illustrates the composition 800 of modules used for calculating incident duration and local impact;

FIG. 9 illustrates a portion 900 of a tree diagram developed from a traffic incident database;

FIG. 10 illustrates a scatter plot 1000 of a traffic incident data, including the prediction of the present invention and the actual traffic data returning to normalcy;

FIG. 11 illustrates in flowchart format 1100 the interactions of the algorithm modules 800 for predicting the incident duration and local impact; and

FIG. 12 illustrates an exemplary hardware/information handling system 1200 for incorporating the present invention therein, including exemplary non-transitory storage medium (e.g., storage medium) 1244 for storing steps of a program of a method according to the present invention.

### DETAILED DESCRIPTION OF AN EXEMPLARY EMBODIMENT OF THE INVENTION

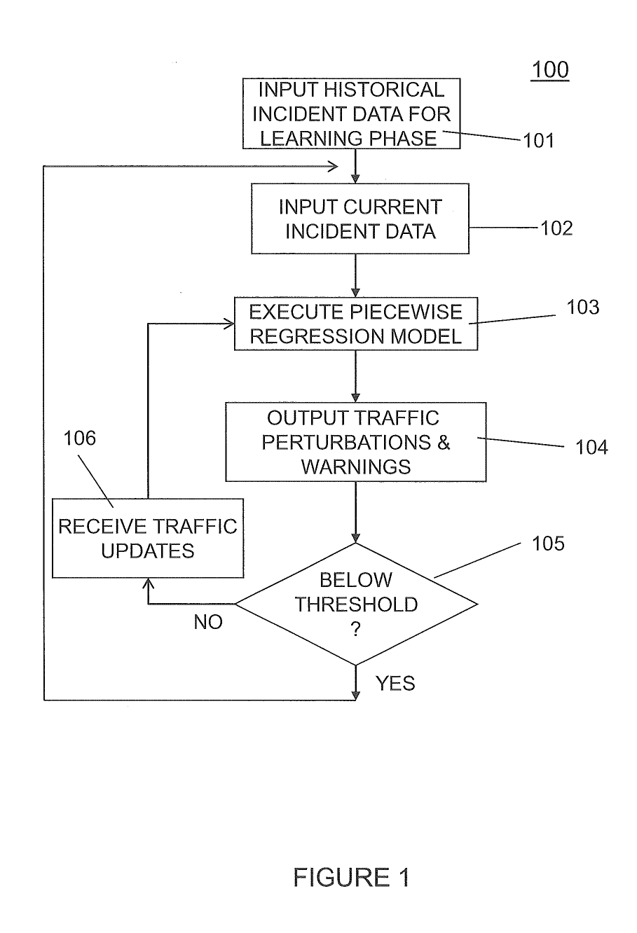

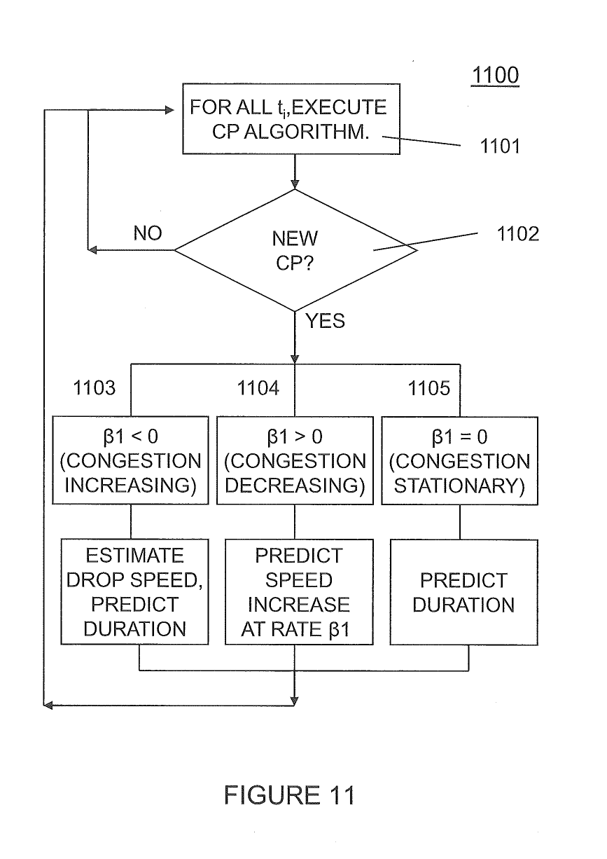

Referring now to the drawings, and more particularly to FIGS. 1-12, an exemplary embodiment of the method and structures according to the present invention will now be described.

The present invention is based on using data on historical incidents in a network, their properties and posteriori observed impacts, in conjunction with data on the traffic on the network. Although the following discussion is exemplarily directed to transportation networks, it applies equally to other types of networks, even though some such networks, such as water and energy distribution networks, may be less well tracked and equipped with real-time data provision than transportation networks.

In summary, the present invention provides a robust incident classification method in which incidents are classified based on their observed duration and local impact, using a hierarchical method robust to unobserved incident features and allowing for online updates. It further uses adaptive online predictions in which a Bayesian change-point method is combined with a statistical smoothing technique that updates online the local impact prediction. A conservation law propagation model allows for model-based control that predicts the incident impact on a sub-network, thereby providing a causal model-based impact propagation.

As shown exemplarily in FIG. 1, inputs into the method 100 of the present invention includes the historical data of previous traffic incidents and traffic measurements, which is used, in step 101, by the tool to learn typical traffic flow properties and the effects of these incidents on traffic flow. Properties of such traffic incidents may include such parameters as the incident type, the type of road, the time of day, the speed limit, the number of lanes, the number of vehicles involved, the number of persons injured, weather conditions, whether emergency vehicles are called on site, etc. Additional data for this learning phase include traffic observations such as speed, flow, density (or occupancy) measurements on the road network.

Upon occurrence of a new incident, in step 102, the tool uses an overall model that takes as input the properties of the incident, the current traffic conditions, and the prediction of recurrent traffic conditions. New incidents could be detected automatically by the system, based on determining a significant change from normal traffic flow at a specific location in the network. Additionally, a manual input could quickly identify an incident location, so that the system could move more quickly into its prediction phase for that incident. Similarly, a manual input might be useful for entering incidents that would result from planned events such as maintenance activities in the network.

The system then determines, in step 103, the spatio-temporal domain on which the incident significantly perturbs traffic flow, in a positive or negative way, as measured using typical operational metrics such as total travel time, total delay, total distance traveled, total served vehicles, etc. The incident evaluations will continue until the system determines that the system traffic has returned to a normal level, in step 105.

As new data becomes available during the incident development, in step 106, the prediction of the impacted spatio-temporal domain, as well as the quantification of this impact, are updated. In step 104, the system also triggers warning around critical times at which the predicted congestion caused by the incident leads to problematic configurations, such as spill-back on ramps or intersections, gridlock, traffic jam at a location with poor visibility, etc. Warnings are also triggered for high likelihood of future problematic conditions or notable conditions from a traffic operator perspective, such as maximum incident impact or queue lengths greater than a predetermined amount.

The predicted quantities are defined as speed or occupancy/density values on a spatio-temporal discretization grid defined by the input data resolution. Based on a history of incidents and traffic observations, a decision tree model predicts the time extent during which the incident will impact traffic flow at the location at which the incident occurs. Based on a history of incidents and traffic observations, a piecewise affine regression model including a change-point detection algorithm computes the most likely traffic values (speed or occupancy) at the location at which the incident occurs. Based on a history of traffic observations, predicted local incident impact, and predicted network-wide recurrent traffic conditions, a calibrated fluid dynamic model propagates the traffic perturbations resulting from the incident, on a neighborhood of the incident. The spatial neighborhood on which the incidents impacts traffic flow is adaptively extended until the perturbation becomes lower than a certain threshold. Similarly, at any point in time when it is detected that the incident impact prediction is not significantly different form the recurrent traffic prediction, the system terminates and announces the end of the incident event. As new data becomes available, the local impact of the incident is updated by conditioning on the observed traffic conditions since the incident start. The spatio-temporal domain on which the incident impacts traffic flow is updated based on the update of the local prediction.

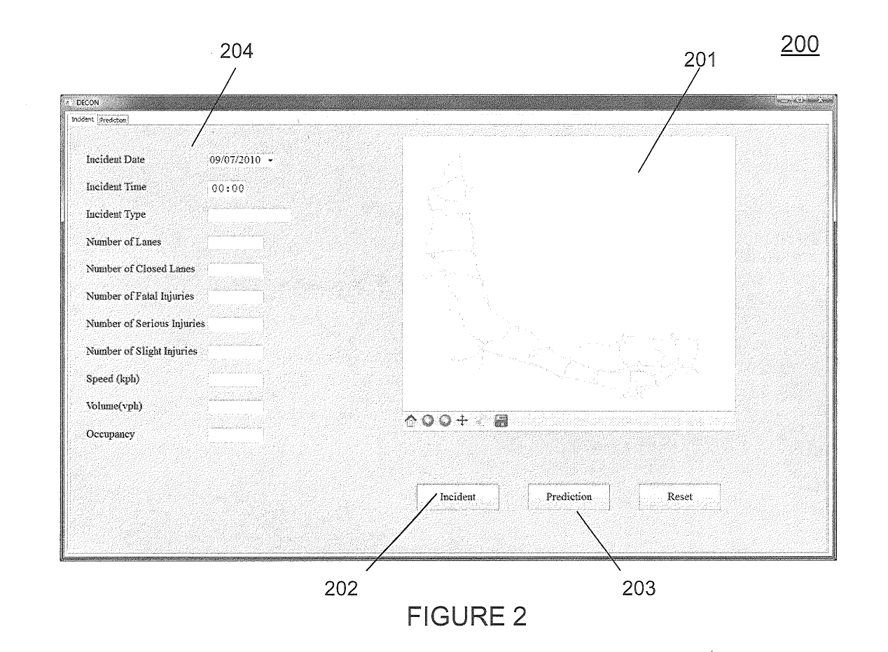

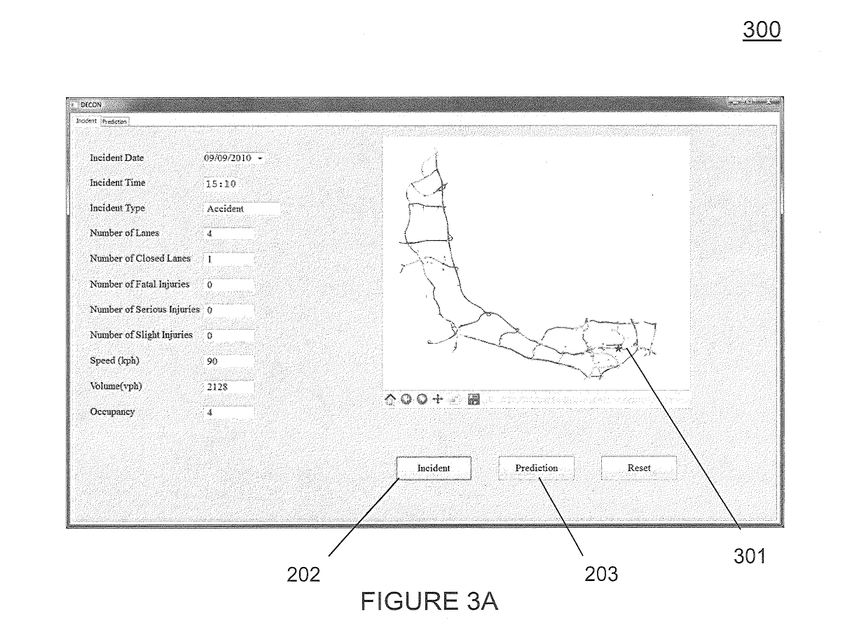

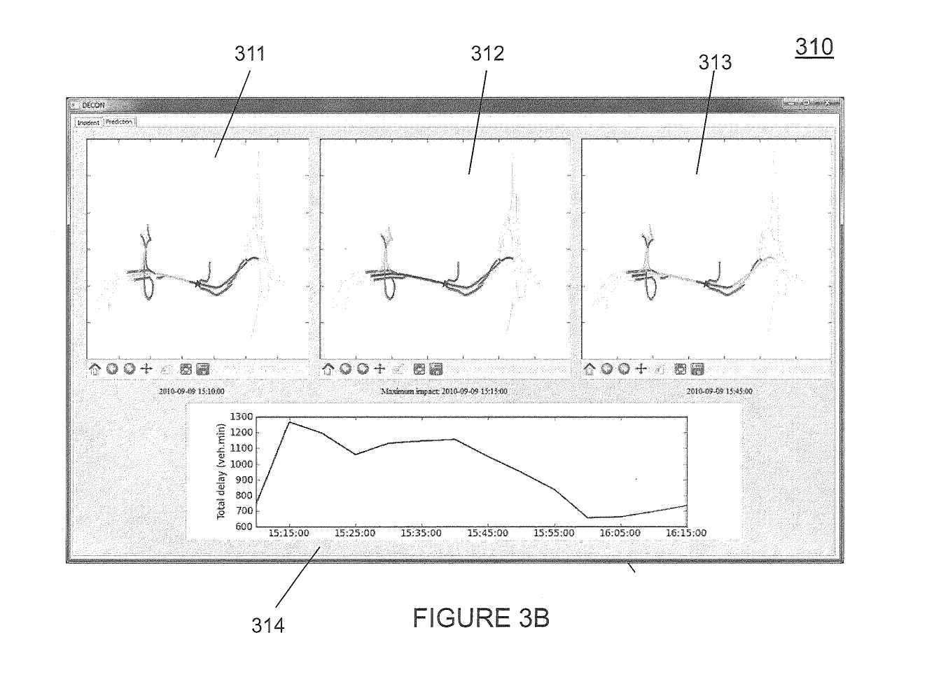

The underlying mathematical modeling method is described in greater detail in a section below. But before presenting this underlying mathematical model, graphical representations from a prototype tool exemplarily embodying the present invention are presented in FIG. 2 through FIG. 6B, including four examples in FIGS. 3A-6B of various incidents that demonstrate the capabilities of this invention.

The home screen presentation 200 of the tool is presented in FIG. 2, which shows on the right side a map 201 of the traffic network under evaluation. The prototype has two tabs 202, 203 at the bottom edge.

The first tab 202 is named “Incident” and is selected in order to generate an incident from an historical database of real incidents. On the left are listed the properties 204 of the incidents displayed, all of which are quite explicit by their respective nomenclatures. For each incident, whether based on historical data or an actual incident, the map 201 will present colors that denote traffic speeds, and a blue star will denote the location of the incident, although these colors do not show up in the black and white diagrams of these exemplary figures.

The second tab 203 named “Prediction” permits a view of subset of the visuals that can be generated from the output of the invention.

FIG. 3A shows a first example representation 300 of an historical incident, as would appear from the “Incident” tab 202. The blue star 301 is the incident location. When the “Prediction” tab 203 is selected, the tool will present the representations 310 shown exemplarily in FIG. 3B. On the top are three maps 311, 312, 313 representing a prediction of the incident impact at different times, in chronological order from left to right. Again, there will be colors that denote the predicted traffic speed, as resulting from the incident. On the bottom is a graph 314 illustrating the prediction of the evolution of a metric of interest, here the total delay, as a function of time.

All these predictions 311-314 are made at the start time of the incident. However, for an actual incident, all of these predictions are updated every time new data is collected, as the incident evolves.

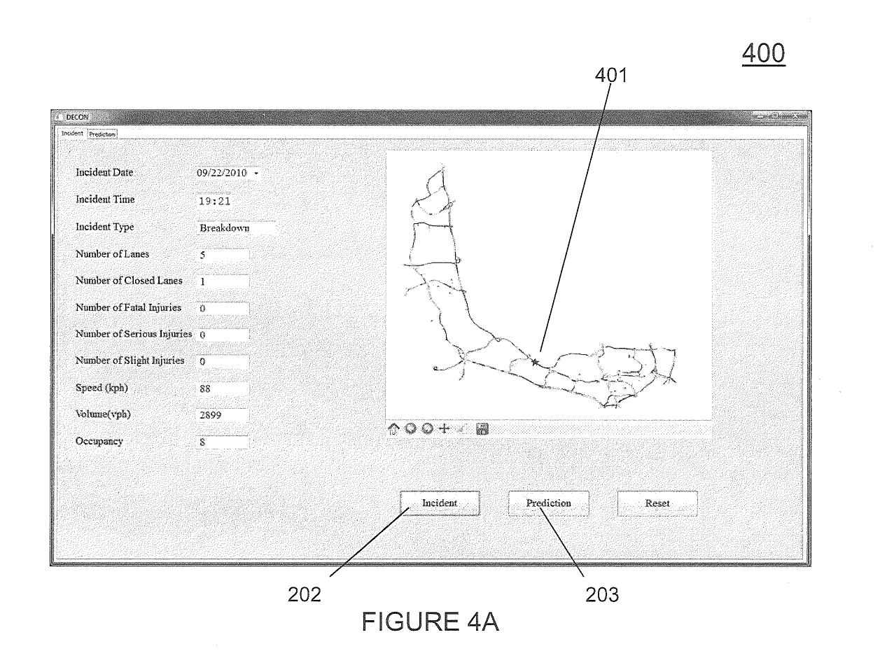

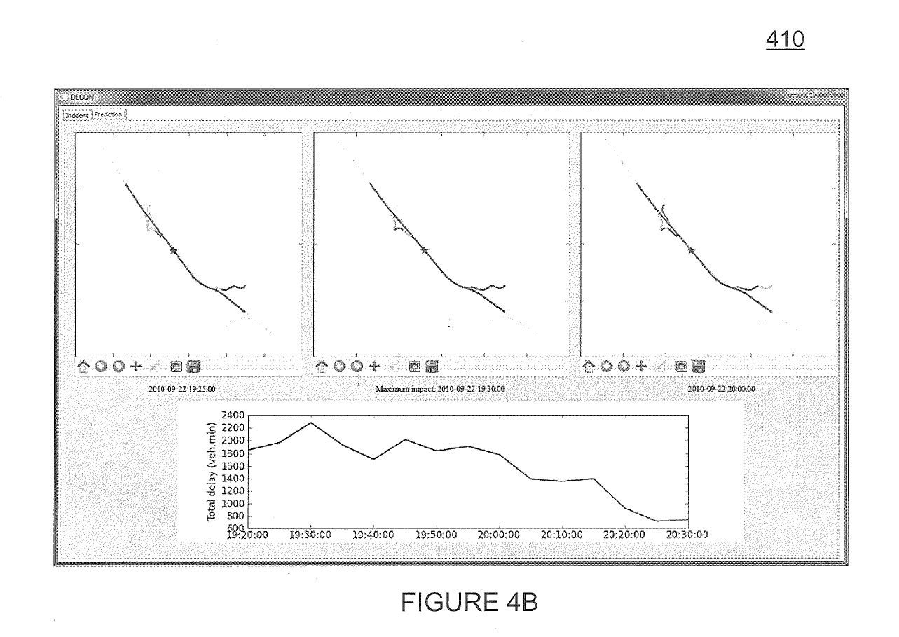

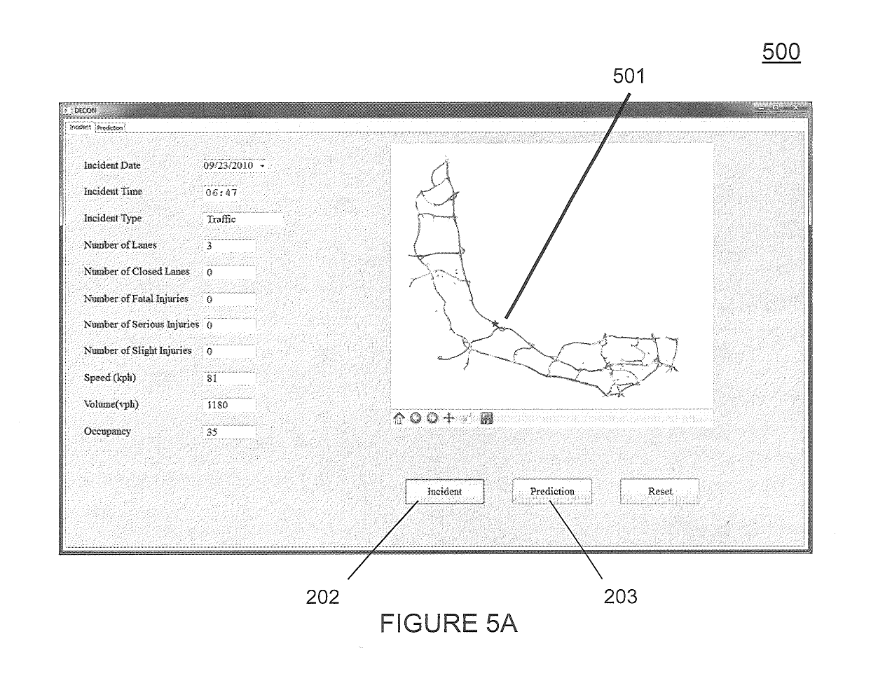

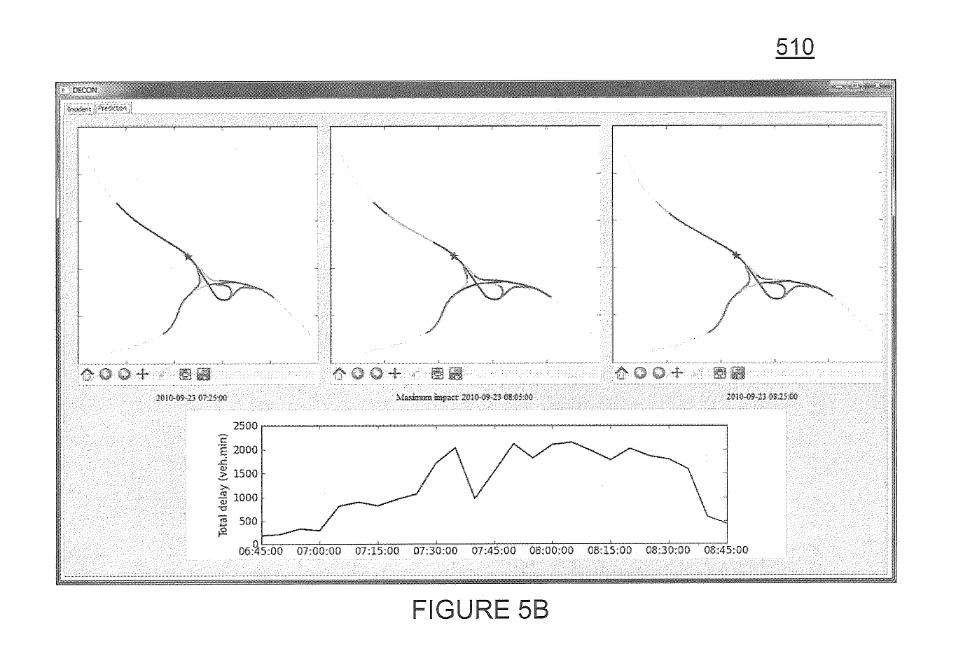

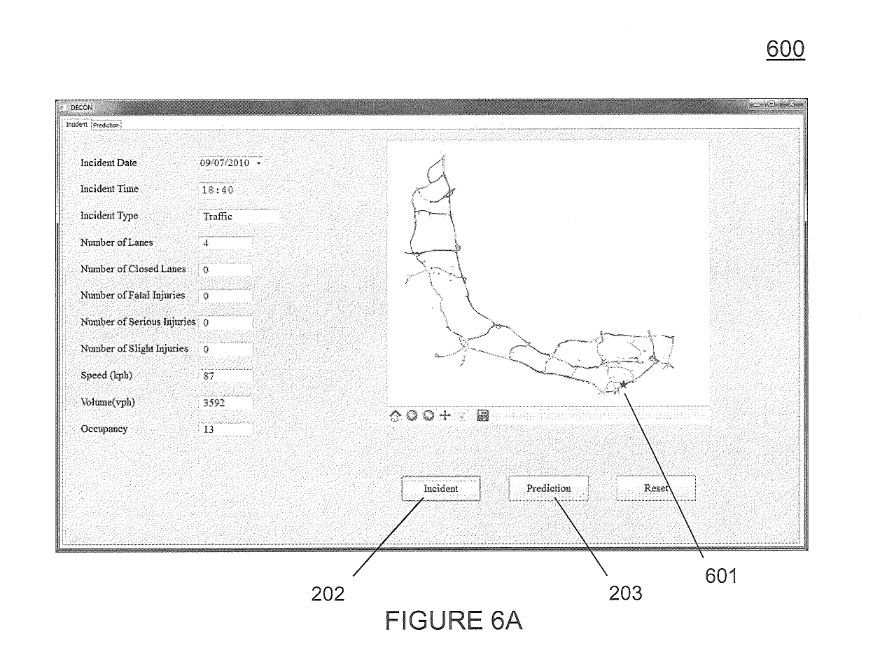

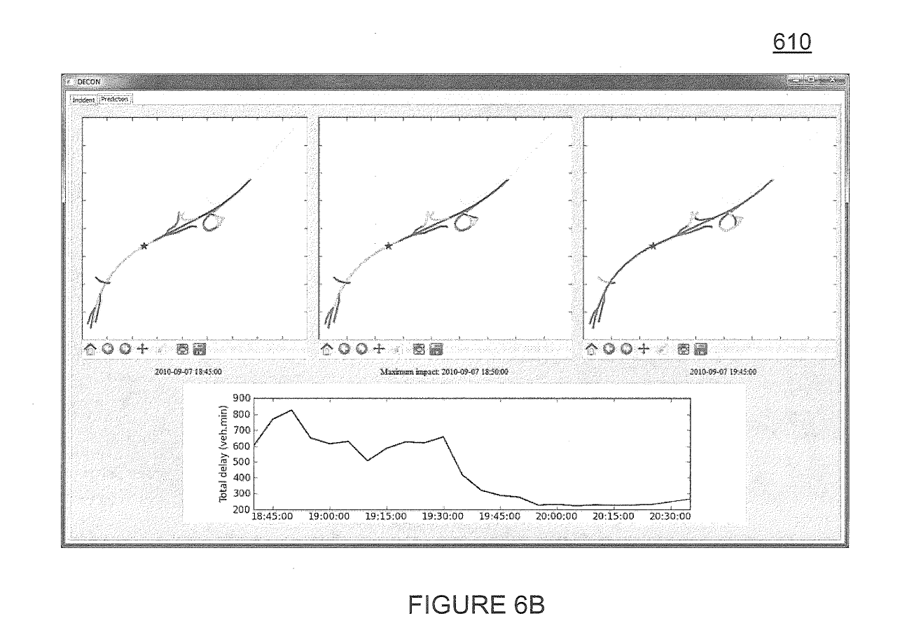

Similarly, FIG. 4A shows a second historical incident 400 at location 401, and FIG. 4B shows the predictions 410 resultant from this second incident. FIGS. 5A and 6A show third and fourth incidents 500, 600, at locations 501,601, and FIGS. 5B and 6B show their corresponding predictions 510,610. It should be noted that the delay graphs at the bottom of the prediction pages 311-610 all demonstrate how the delays have begun to stabilize on the right side of the graph toward a pre-incident level of delay.

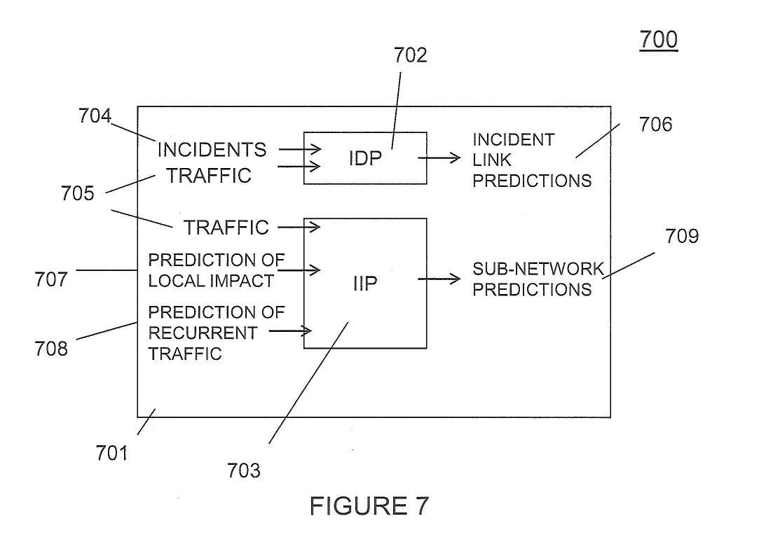

FIG. 7 shows in block diagram format 700 how the prediction module 702 and the incident propagation module 703 of the present invention fit into a larger traffic tool 701, such as one exemplarily described in co-pending Application entitled “Method and System for Optimizing Road Traffic Control in the Presence of Incidents”, having identification YOR920130472US1, the contents of which are incorporated herein by reference. The formulation and algorithmic approach to be used by the Incident Duration and local impact Prediction (IDP) 702 and Incident network-wide Impact Propagation (IIP) 703 components of the larger tool 700 is described below.

The objective of the traffic tool 701 is to provide optimal response plans to mitigate the impact of one or more incidents on a road network. The IDP and IIP modules 702, 703 predict the impact of detected traffic incidents. This prediction is used as input for the optimization of response plans, as executed by the traffic tool 701.

More specifically, the function of the IDP module 702 is to predict the impact of an incident at the location at which the incident occurs on the road network. We assume that the IDP accepts as input:

A feed of incidents 704 detected either by humans (in the traffic command center or on the road) or by an algorithm or dedicated module (such as an Incident Detection Module within larger tool 701). The detected incidents are assumed to be characterized by their incident properties, including incident type (accident, breakdown, heavy congestion, flood, fire, gas, etc), road category (expressway, arterial road, etc), number of lanes blocked, etc,

A feed of real-time traffic data, including speed, occupancy or flow.

The output 706 of the IDP consists of speed or occupancy predictions on the network link on which the incident occurs.

The function of the IIP module 703 is to predict the impact of an incident on the road network. We assume that the IIP 703 accepts as input:

a prediction 707 of the local incident impact as speed or occupancy prediction on the incident link (e.g., as given by the IDP 702),

a prediction 708 of recurrent traffic conditions on the whole road network, as link-based speed or occupancy predictions (e.g., as given by a traffic prediction (TP) module of the larger tool 701),

a feed of real-time traffic data 705, including speed, occupancy or flow.

The output 709 of the IIP consists of the sub-network impacted by the incident, as well as a link-based quantification of this impact (e.g., as link-based speed or occupancy predictions).

The following describes the theory underlying the present invention, first by presenting the classification model and breakpoint method composing the local incident impact model, followed by presenting the macroscopic model proposed for the network impact prediction.

### Incident Duration and Local Impact Prediction

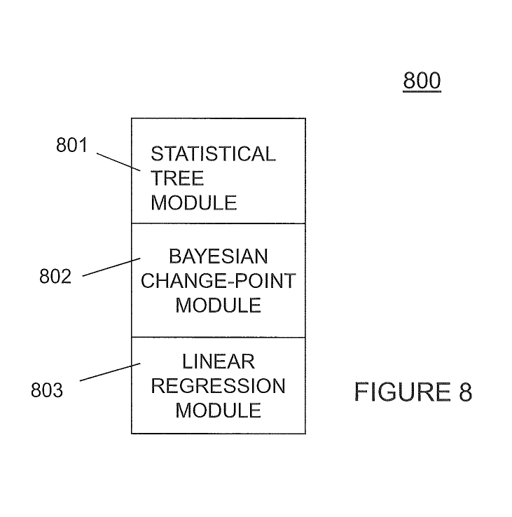

As exemplarily illustrated in FIG. 8, the incident duration and local impact are predicted using a combination 800 of a statistical tree technique 801, a Bayesian change-point method 802, and a linear regression model 803. The following provides an overview of these algorithms and their interaction.

### Model Definition

The first component of the local impact prediction is a regression tree model 801 predicting the duration of the incident. It is an extension to the technique introduced in He et al., which allows for updated predictions as new data becomes available. Specifically, with X the random variable representing the duration of an incident, the conditional distribution X|X>t is used to provide an updated prediction of the duration of the incident as it evolves.

A regression tree is a hierarchical approach for piecewise-constant regression used to permit prediction of continuous and discrete variables. Regression trees differ from simple linear regression models in that they include multiple conditions under which only a subset of the predictors are included at each branch of the tree. As an example using traffic and incident data, the dependent variable may be the duration of the incident and the full set of predictors may include the traffic level prior to the incident, the type of incident, the time of day, the location, the type of road, and whether or not there are any trucks involved.

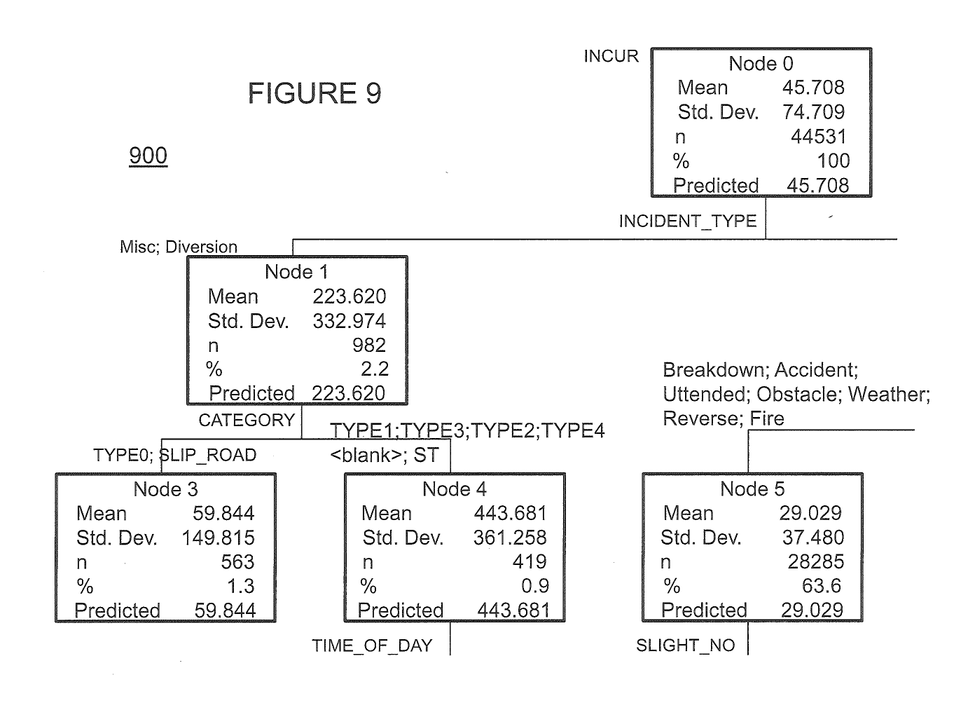

A branch of the tree may include only the traffic level prior to the incident if it is between speeds of 40 kph and higher, the type of road, and the type of incident. Other branches can include other ranges of the continuous variables and other values of the discrete variables. FIG. 9 shows an example of a portion 900 of a tree diagram developed from a traffic incident database using the CART (Classification and Regression Trees) method.

CART is a binary decision tree learning technique that produces either classification or regression trees depending upon whether the dependent variable is respectively categorical or numerical. In the case of traffic incident duration, the output duration is a continuous quantity, so the implementation of the CART method on traffic incident data provides a regression tree such as exemplarily shown in FIG. 9.

A second technique known in the art to develop a decision tree from traffic incident data is the CHAID (Chi-squared Automatic Interaction Detection). At each step, the CHAID algorithm chooses the independent (predictor) variable that has the strongest interaction with the dependent variable once. Categories of each predictor are merged if they are not significantly different with respect to the dependent variable. The big difference between models developed from CART and CHAID is that the CHAID model can have more than two leaves for each node. That difference implies that the CHAID tree is less deep but wider, so that the tree construction time is shorter for the CHAID algorithm.

The CART-derived tree diagram 900 shown in FIG. 9 shows that INCIDENT_TYPE is the best predictor of INCDUR (incident duration), which is the variable of most interest in the method of the present invention. For the scale dependent variable, each node indicates the mean value and the standard deviation of the dependent variable, the number of cases in the node, and the value predicted for the target. In the example shown in FIG. 9, the mean of the incident duration of Node 0 is about 45.7 minutes, with a standard deviation of about 74.7 minutes.

In the tree diagram of FIG. 9, for Node 1 (Miscellaneous, Diversion incident type), CATEGORY is another significant predictor of INCDUR. For the TYPE0 and SLIP_ROAD category of incidents, CATEGORY is the only significant predictor of INCDUR and, since there are no child nodes below it, this node 3 (TYPE0, SLIP_ROAD) is considered a terminal node of the CART algorithm result for this set of incident data. For the TYPE1, TYPE3, TYPE2, TYPE4, <blank>, and ST categories, the next best predictor is TIME_OF_DAY.

Returning now to FIG. 8, the second component of the algorithm is a Bayesian change-point detection model 802. This component 802 is used in the present invention because a sequence of observations can undergo sudden changes at unknown times. As is known in the art, the change-point detection process can be modeled by supposing that there is an underlying sequence of parameters partitioned into contiguous blocks of equal parameter values, with the beginning of each block considered to be a change point. Observations are then assumed to be independent in different blocks given the sequence of parameters. In a Bayesian analysis, probability distributions are typically given for both the change points and the parameters.

The observation model for the change-point time κ reads:

$$Y ( {t}_{i} ) • \{ \begin{matrix}N ( {β}_{0} {t}_{i} + {α}_{0} , {σ}^{2} ) , if ( {t}_{i} \leq κ ) \\ N ( {β}_{1} {t}_{i} + {α}_{1} , {σ}^{2} ) , if ( {t}_{i} > κ )\end{matrix}$$

where the observations Y (tᵢ) corresponding to different observation times tᵢ are independent. The priors β₀, β₁, α₀, α₁, σ² and associated hyper-priors are not explicited here in the interest of space, but these priors represent the slopes (β) and intercepts (α) of each piece of the initial incident duration estimation. Specifically, the first and second equations in (1) respectively describe the evolution of traffic conditions at the location of the incident, before and after the change-point time denoted by κ. If the posterior distribution of κ is such that Pr(κ=t|Y (t1), . . . , Y (tN))>0.5 for some t ε [t1, tN]we conclude that a change-point has occurred.

For example, by setting β₀=0 and constraining β₁ to be negative, and if Y () denotes the speed, then κ allows us to assess if speed has evolved into a phase where the speed drops. In an exemplary implementation, a Gibbs sampler is used to compute the desired posterior distributions. It is noted that a Gibbs sampler is known in the art as a Markov chain Monte Carlo (MCMC) algorithm for obtaining a sequence of observations which are approximated from a specified multivariate probability distribution, such as a joint probability distribution of two or more random variable, when direct sampling is difficult.

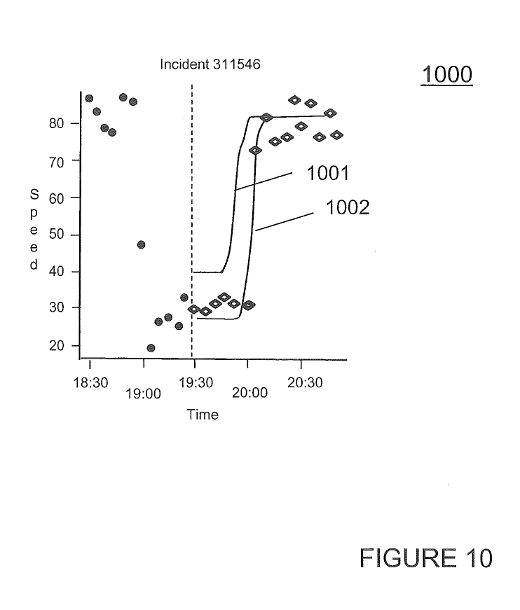

FIG. 10 shows an exemplary scatter plot 1000 for a specific traffic incident (Incident No. 311546), in which SPEED and TIME data points are plotted. From this data, it can be readily seen that the incident occurred at approximately 19:00, and the present invention would have detected the change point indicative of the incident. The plots shown on the right side of FIG. 10 show the predicted traffic 1001 by the method of the present invention and the actual traffic 1002 for this incident, including the change point of the actual data plot 1002 indicative of the return to normalcy.

Returning again to FIG. 8, the third component of the local impact prediction is a regression model 803 that is applied whenever the change-point module determines that β₁<0. In such a case, the linear regression model is used to determine the magnitude of the speed drop from the previous phase, using β₁ as the predictor. This regression model is fit offline using historical incident data.

### Sequential Online Predictions

In this section are described the online interactions 1100 of the models described in the previous section. In order to know the current phase, the change-point algorithm is applied at each discretization time, in step 1101. If a new change-point is detected in step 1102, a new phase is set to have begun; the previous phase does not enter into subsequent consideration due to the assumed independence (see equation (1)). The prediction of the local impact is performed differently depending on the nature of the phase β₁<0 (congestion increasing, step 903), β₁>0 (congestion decreasing, step 904) or β₁=0 (stationary phase, step 905). It is noted that “congestion” is associated with speed data. If occupancy or density data is presented, “congestion increasing” would correspond to positive beta and “congestion decreasing” would correspond to negative beta. The various predictions are described below, where we let α₀ represent the speed before it was adversely affected by the incident.

β₁<0: first, the regression model estimates the speed that the profile is going to drop to. Second, the tree model predicts how much longer the incident (speed drop) will last, after which it is assumed that speed will recover to α₀.

β₁=0: if the current speed value is below α₀, the tree model is used to predict how much longer this phase will continue, before recovering to α₀. If the current speed is above α₀, it is assumed that the incident impact has already played out to completion, and that speed will remain constant for the foreseeable future.

β₁>0: this would indicate that the speed is beginning to recover. Hence the forecast consists of predicting that speed will increase at rate β₁ until it reaches α₀, whence it would level off.

The local incident impact prediction, corresponding to perturbations in traffic conditions at the location of the incident, are then propagated on a sub-network using a network conservation law model, described in the following section.

### Incident Network-Wide Impact Propagation

The prediction of the impact of an incident on the road network is based on the propagation of the prediction of the local impact of the incident, computed using a statistical model as described in the previous section. The prediction of the impact of the incident on the network accounts for historical relations between speed and flow which characterize the performance of a link, and for calibrated splitting rates at junctions for application of a similar model to traffic estimation.

The link model used for incident impact propagation consists of the offline calibration of a quadratic-hyperbolic-linear fundamental diagram, expressed in speed-flow coordinates:

$$q ( v ) = \{ \begin{matrix}cv ( 1 - \frac{v}{{v}_{ma x}} ) , if ( {v}_{c +} \leq v ) \\ {q}_{ma x} , if ( {v}_{c -} \leq v \leq {v}_{c +} ) \\ {ρ}_{ma x} \frac{v}{1 + \frac{v}{w}} , if ( v \leq {v}_{c - 1} )\end{matrix} \qquad ( 2 )$$

where the parameters vₘₐₓ, qₘₐₓ, ρₘₐₓ respectively denote the maximal velocity, flow, density, where v_{c-}, v_{c+} are calibrated from historical data, and where c, w are defined by continuity of the flux function. Based on the incident features, the fundamental diagram at the incident location is scaled in order to account for the potential capacity drop and speed reduction at the location. The model computes speed and flow values in a spatio-temporal cone around the incident, using a first-order scalar conservation law model expressed in velocity variables:

$$\frac{\partial \frac{q ( v ( t , x ) )}{v ( t , x )}}{\partial t} + \frac{\partial q ( v ( t , x ) )}{\partial x} = 0. \qquad ( 3 )$$

The flow across each junction is obtained by solving a linear program, which computes the maximal allowable flow across the junction, based on link traffic conditions, and calibrated splitting rates. At each time discretization, the linear program provides link boundary conditions for the link model (2)-(3), at the junctions located in the interior of the area impacted by the incident. Network boundary conditions for this propagation model correspond on the cone axis to the local incident impact prediction computed from the statistical model described in the previous section, and to the prediction of recurrent traffic conditions on the cone boundary.

### Exemplary Hardware Implementation

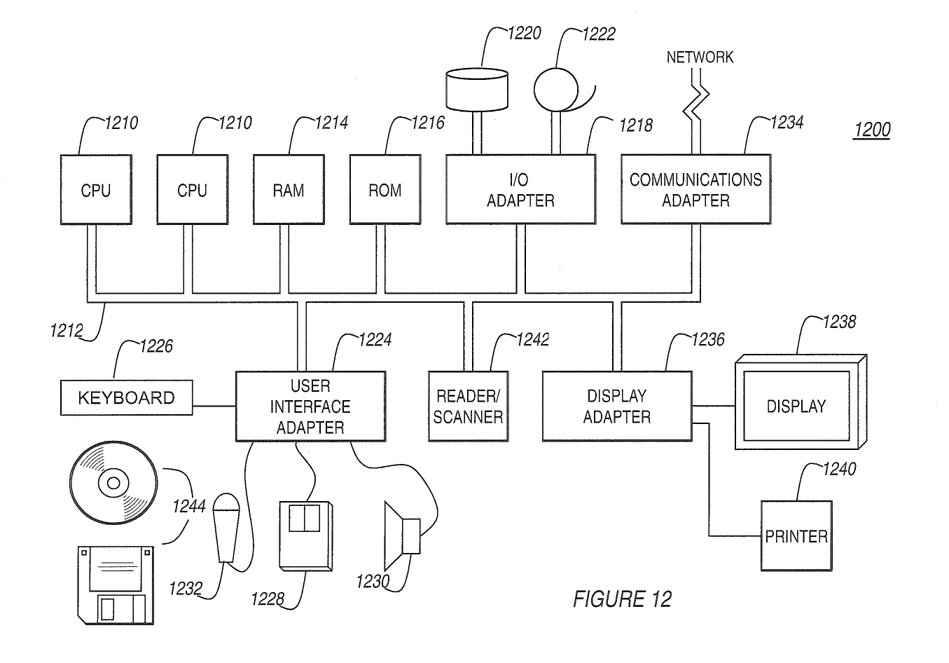

FIG. 12 illustrates a typical hardware configuration of an information handling/computer system in accordance with the invention and which preferably has at least one processor or central processing unit (CPU) 1210.

The CPUs 1210 are interconnected via a system bus 1212 to a random access memory (RAM) 1214, read-only memory (ROM) 1216, input/output (I/O) adapter 1218 (for connecting peripheral devices such as disk units 1221 and tape drives 1222 to the bus 1212), user interface adapter 1224 (for connecting a keyboard 1226, mouse 1228, speaker 1230, microphone 1232, and/or other user interface device to the bus 1212), a communication adapter 1234 for connecting an information handling system to a data processing network, the Internet, an Intranet, a personal area network (PAN), etc., and a display adapter 1236 for connecting the bus 1212 to a display device 1238 and/or printer 1240 (e.g., a digital printer or the like).

In addition to the hardware/software environment described above, a different aspect of the invention includes a computer-implemented method for performing the above method. As an example, this method may be implemented in the particular environment discussed above.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method for predicting an impact of an incident on a system, the method comprising:
reading incident properties and traffic conditions of at least one historical incident to calibrate one or more parameters of a traffic model, as executed by a processor on a computer;
receiving current traffic conditions and a prediction of recurrent traffic conditions;
receiving an indication of a current incident in the system;
predicting a duration of a current incident and traffic conditions at a location at which the current incident occurs; and
calculating a prediction of traffic conditions in the system, based on the calibrated model parameters, the current traffic conditions, the prediction of recurrent traffic conditions, and the predicted duration of the current incident and traffic conditions at the current incident location.

2. The method of claim 1, wherein the calculating of the traffic condition prediction further comprises detecting critical time points in a development of the current incident.

3. The method of claim 1, wherein the predicting of the duration of the incident and network conditions at the location at which the incident occurs uses a model for incident classification and duration estimation and a nonlinear regression model.

4. The method of claim 3, wherein the nonlinear regression model comprises a piecewise-linear regression and the prediction of network conditions comprises propagating a predicted network state at the location of the current incident, as provided by the prediction of the incident duration, using a temporal network evolution model, where the local network characteristics at the incident location are provided by the model for incident classification and duration estimation and the piecewise linear regression model at the current incident location.

5. The method of claim 1, wherein the prediction of the duration of the incident and traffic conditions at the current incident location uses a decision tree model for incident classification and duration estimation and the prediction for traffic at the current incident location uses a nonlinear regression model including a change point detection algorithm.

6. The method of claim 5, further comprising propagating a predicted traffic state provided by the prediction at the location of the incident, using a macroscopic flow model, for which initial conditions are given by the current traffic state, and boundary conditions are given by recurrent traffic states and the traffic prediction at the incident location provided by the decision tree model and the nonlinear regression model including the change point detection algorithm.

7. The method of claim 1, wherein the system describes a road transportation network.

8. The method of claim 1, wherein an incident denotes an event reported manually.

9. The method of claim 1, wherein an incident denotes a non-recurrent event detected programmatically.

10. The method of claim 1, wherein the impact denotes a function of one or more of traffic flow, speed, density, and occupancy.

11. The method of claim 1, further comprising providing an output indication of critical times at which a predicted congestion caused by the current incident has a potential to lead to problematic configurations.

12. The method of claim 6, wherein boundaries for the boundary conditions can be any one of static, time-varying, or moving with a congestion front.

13. The method of claim 2, wherein the predictions and critical time points are updated as new data becomes available.

14. The method of claim 1, wherein the system describes a water network.

15. The method of claim 1, wherein the system describes an energy grid network.

16. The method of claim 1, as embodied in a set of computer-readable instructions stored that are tangibly embodied in a non-transitory storage device.

17. An apparatus, comprising:
a central processing unit (CPU); and
a memory,
wherein tangibly embodied in the memory is a set of machine-readable instructions that, when executed by the CPU, executes a method for predicting an impact of an incident on a system and for predicting critical time points in a development of the incident over time, the method comprising:
receiving data for current traffic on the system;
receiving an indication of an incident in the system and an associated set of incident properties;
retrieving, from the memory, one or more control parameters of a traffic model derived from an analysis of at least one historical incident and its associated incident properties;
receiving a prediction of recurrent traffic in the system and a prediction of a duration of the incident; and
predicting traffic on the system, based on the predicted recurrent traffic, the predicted duration of the incident, and the one or more control parameters derived from the analysis of the at least one historical incident.

18. The apparatus of claim 17, wherein the prediction of the duration of the incident and traffic conditions at the current incident location uses a decision tree model for incident classification and duration estimation and the prediction for traffic at the current incident location uses a regression model including a change point detection algorithm.

19. A non-transitory, computer-readable storage medium tangibly embodying a set of computer-readable instructions for executing a method of predicting an impact of an incident on a system, the method comprising:
reading incident properties and traffic conditions of at least one historical incident to calibrate one or more parameters of a traffic model, as executed by a processor on a computer;
receiving current traffic conditions and a prediction of recurrent traffic conditions;
receiving an indication of a current incident in the system;
predicting a duration of a current incident and traffic conditions at a location at which the current incident occurs; and
calculating a prediction of traffic conditions in the system, based on the calibrated model parameters, the current traffic conditions, the prediction of recurrent traffic conditions, and the predicted duration of the current incident and traffic conditions at the current incident location.

20. The storage medium of claim 19, as comprising at least one of:
a read only memory (ROM) device on a computer, as storing a program to be selectively executed by the computer;
a random access memory (RAM) device on a computer, as storing a program currently being executed by the computer;
a memory device associated with a server on a network, as storing a program to be selectively downloaded to a device on the network; and
a standalone memory device, as storing a program to be selectively inserted in an input device for uploading the program to a computer.
